(19) United States
(12) Patent Application Publication
(10) Pub. No.: US 2022/0365950 A1
(43) Pub. Date: Nov. 17, 2022

(54) AUTOMATED DOCUMENT TAGGING PLATFORM SYSTEM

(71) Applicant: NeoLicense LLC, Katy, TX (US)

(72) Inventors: Michael Patrick Duffy, Katy, TX (US); James Larry Poole, III, Katy, TX (US); James Christopher Keck, Fulshear, TX (US)

(21) Appl. No.: 17/320,943

(22) Filed: May 14, 2021

(51) Int. Cl. G06F 16/28; G06F 16/93; G06F 9/451; G06F 40/117; G06F 40/197

(52) U.S. Cl. CPC G06F 16/285; G06F 16/93; G06F 9/453; G06F 40/117; G06F 40/197; G06F 3/0482

(57) ABSTRACT

A method for a guided tagging of a document and a system comprising a memory and at least one processor operatively coupled to the memory, the processor being configured to present a user interface including a document tagging wizard for providing a guided tagging of a first document based on tagging rules associated with a characteristic of the first document; upload the first document into a document database to be included among a plurality of documents; group the plurality of documents into one or more families of documents, each of the families of documents having a customized version of the tagging rules; associate the first document with at least one of the families of documents; generate a tagged version of the first document via the user interface; and update the customized version of the tagging rules based on the tagged version of the first document.

### BACKGROUND

### Technical Field

The present disclosure generally relates to document review and more specifically to an automated document tagging platform system

### Description of the Related Art

Document management systems are computer-based systems to manage contents of digital files representing documents. Typical computer systems manage an entire digital document as a whole (i.e., as a single computer file representing the entire document). When managed as a single document, changes made to the digital document may be obfuscated by the other information in the digital document. That is, the digital document may contain many parameters and parts that are all independently important in providing for what the digital document as a whole represents. Previous digital document management systems manage the digital document as a single entity without modularity for review/approval and security. Despite advances in document creation, there remains a need for techniques that allow parties to more efficiently and securely manage contracts, including selecting appropriate documents and identifying key terms within a document. Examples of document management systems are shown and described in co-owned international patent application PCT/US/2020/017886, filed Feb. 12, 2020, the entire contents of which are hereby incorporated by reference.

It should be understood that the background is provided to aid in an understanding of the present invention and that nothing in the background section shall be construed as an admission of prior art in relation to the inventions described herein.

### SUMMARY

In an embodiment of the present disclosure, a system may include a memory and at least one processor operatively coupled to the memory, the processor being configured to: present a user interface including a document tagging wizard for providing a guided tagging of a first document based on tagging rules associated with a characteristic of the first document; upload the first document into a document database to be included among a plurality of documents; group the plurality of documents into one or more families of documents, each of the families of documents having a customized version of the tagging rules; associate the first document with at least one of the families of documents; generate a tagged version of the first document via the user interface; and update the customized version of the tagging rules based on the tagged version of the first document. The processor may be further configured to: generate an analytics report for the at least one of the families of documents associated with the first document. The analytics report may provide an actionable item for at least one other document within the at least one of the families of documents associated with the first document. The processor may be further configured to generate an alert based on the actionable item. The user interface may further include a first input component for identifying a portion of the first document. The user interface may further include a second input component for identifying a variable of the first document. The variable may be one of the characteristics of the first document upon which tagging rules for the guided tagging of documents is based. The processor may be further configured to associate the identified portion of the first document with the variable of the first document. The variable may include a customized list of variables based on the customized version of the tagging rules. The variable may include a contractual term and/or a legal jurisdiction.

In a further embodiment of the present disclosure, a method may include: presenting a user interface including a document tagging wizard for providing a guided tagging of a first document based on tagging rules associated with a characteristic of the first document; uploading the first document into a document database to be included among a plurality of documents; grouping the plurality of documents into one or more families of documents, each of the families of documents having a customized version of the tagging rules; associating the first document with at least one of the families of documents; generating a tagged version of the first document via the user interface; and updating the customized version of the tagging rules based on the tagged version of the first document. The method may further include generating an analytics report for the at least one of the families of documents associated with the first document. The analytics report may provide an actionable item for at least one other document within the at least one of the families of documents associated with the first document. The method may further include generating an alert based on the actionable item. The user interface may include a first input component for identifying a portion of the first document. The user interface may include a second input component for identifying a variable of the first document. The variable may be the characteristic of the first document associated with the tagging rules. The method may further include associating the identified portion of the first document with the variable of the first document. The variable may include a customized list of variables based on the customized version of the tagging rules.

These and other aspects of the present disclosure are described in greater detail below with reference to the accompanying figures.

### BRIEF DESCRIPTION OF THE DRAWINGS

FIG. 1A is a diagram of an exemplary client device according to aspects of the present disclosure.

FIG. 1B is a diagram of a document tagging platform according to aspects of the present disclosure.

FIG. 1C is a diagram of an exemplary system according to aspects of the present disclosure.

FIG. 2 is an exemplary flowchart illustrating the interaction of the client device of FIG. 1A and the document tagging platform of FIG. 1B.

FIG. 3A is a diagram of an exemplary form (e.g., document tagging wizard) according to aspects of the present disclosure.

FIG. 3B is a diagram of an exemplary system illustrated tagging of an uploaded document, in accordance to aspects of the present disclosure.

FIG. 4A is a flowchart of a method in accordance with aspects of the present disclosure.

FIG. 4B is a flowchart of a method in accordance with aspects of the present disclosure.

FIG. 4C is a flowchart of a method in accordance with aspects of the present disclosure.

FIGS. 5-12 illustrates a user interface in accordance with the present disclosure

### DETAILED DESCRIPTION

Various embodiments and aspects of the present disclosure will be described with reference to the accompanying drawings. The following description and drawings are illustrative of the present disclosure and are not to be construed as limited the disclosure. Numerous specific details are described to provide a thorough understanding of various embodiments of the present disclosure. However, in certain circumstances, well-known or conventional details are not described in order to provide a concise discussion of embodiments of the present disclosure.

The present disclosure is best understood from the following detailed description when read with the accompanying figures. Some portions of the detailed description which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. Such signals may be referred to as bits, values, elements, symbols, characters, terms, numbers, or the like. Unless specifically stated otherwise as apparent from the following discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g., computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

At least certain embodiments of the present disclosure include one or application programming interfaces in an environment with user interface software interacting with a software application. Various function calls or messages are transferred via the application programming interfaces between the user interface software and software applications. Transferring the function calls or messages may include issuing, initiating, invoking or receiving the function calls or messages. Example application programming interfaces transfer function calls to implement scrolling, gesturing, and animating operations for a device having a display region. An API may also implement functions having parameters, variables, or pointers. An API may receive parameters as disclosed or other combinations of parameters. In addition to the APIs disclosed, other APIs individually or in combination can perform similar functionality as the disclosed APIs.

The display region is a form of a window. A window is a display region which may not have a border and may be the entire display region or area of a display. In some embodiments, a display region may have at least one window and/or at least one view (e.g., web, text, or image content). A window may have at least one view. The methods, systems, and apparatuses disclosed can be implemented with display regions, windows, and/or views.

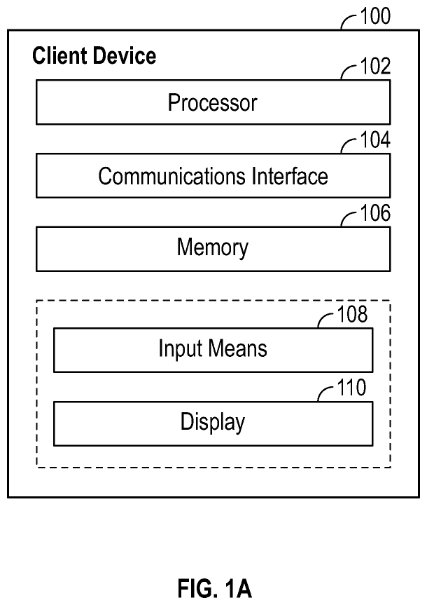

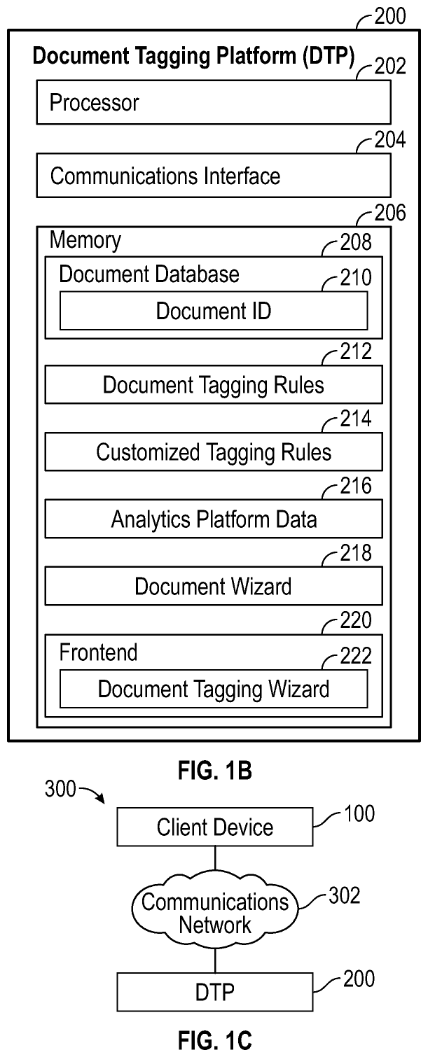

FIG. 1A is a diagram of a client device 100, according to aspects of the present disclosure. The client device 100 may include a processor 102, a communications interface 104, a memory 106, an input means 108 (e.g., keyboard, etc.), and a display 110. According to aspects of the disclosure, the processor 102 may include any suitable type of processing circuitry, such as a general-purpose processor (e.g., an ARM-based processor), an application-specific integrated circuit (ASIC), or a Field-Programmable Gate Array (FPGA). The communications interface 104 may include any suitable type of communications interface, such as a Wi-Fi interface, an Ethernet interface, a Long-Term Evolution (LTE) interface, a Bluetooth Interface, an Infrared interface, etc. The memory 106 may include any suitable type of volatile and non-volatile memory, such as random-access memory (RAM), read-only memory (ROM), flash memory, cloud storage, or network accessible storage (NAS), etc. The input means 108 may include any suitable type of touch panel, such as a capacitive or resistive touch panel. The display 110 may include any suitable type of display such as a liquid crystal display (LCD), a light-emitting diode (LED) display, or an active-matrix organic light-emitting diode (AMOLED) display. In some implementations, the input means 108 may be layered onto the display 110 to form a touchscreen. Although not shown, the client device 100 may include additional (or alternative) input devices, such as a microphone, a keyboard, a mouse, etc.

FIG. 1B is a diagram of an example of a document tagging platform (DTP) 200 in accordance with the present disclosure. As shown in FIG. 1C, a system 300 may include a communications network 302 that electronically couples the document tagging platform 200 with the client device 100. The document tagging platform (DTP) 200 may be connected to the client device 100 via the communications network 302 that may include one or more of the Internet, a local area network (LAN), a wide area network (WAN), telephone network a cellular network, a cable TV distribution network, and/or any other suitable type of network. Although in the present example, the communications network is the Internet, it will be understood that the present disclosure is not limited to any specific type of network (or networks) for connecting the nodes in a system, which includes the document tagging platform (DTP) and the client device 100, to one another. For example, in some implementations, the communications network may be a restricted-access network, such as the network of a cable TV provider that is used for the distribution of cable TV among a plurality of subscribers.

Referring back to FIG. 1B, the document tagging platform (DTP) 200 may include a processor 202, a communications interface 204, and a memory 206. The communications interface 204 may be in electronic communication with the communications interface 104 of a respective client device 100. The memory 200 may include any suitable type of volatile and non-volatile memory, such as random-access memory (RAM), read-only memory (ROM), a hard disk (HD), a solid-state drive (SSD), a CD-ROM, flash memory, cloud storage, or network accessible storage (NAS). The document tagging platform (DTP) 200 may automate and/or facilitate a review of documents. For example, the DTP may facilitate review of documents by provided tagging rules for particular types of documents. The tagging rules updated by the system as it self-learns based on similar documents uploaded in the system by learning terms that appear in document types with frequency as well as similar document structures and layouts. The DTP 200 may further guide less experiences users/clients through the review of document types by querying the user/client to identify areas/sections and terms within a document that should be present in a particular document type. Identified sections of a document may be highlighted and given a tag as corresponding to a particular type of information and particular terms within the document may be further tagged.

The memory 206 of the document tagging platform 200 may include a document database 208 in which each document is provided with a document ID 210. The memory 206 may further include tagging rules 212 and 214. The tagging rules may be customized for documents in general, for types of documents, and for each particular document. For example, the tagging rules 212 may be for all documents and the tagging rules 214 may be particularized for the document currently being reviewed. Analytics platform data 214 may be stored to facilitate an analysis of how documents have been tagged such that trends may be determined and/or analyzed such that the system (i.e., platform 200) may apply a self-learning function to facilitate tagging of future documents and/or a review of already stored documents as a quality control check. The analytics platform data 214 that is stored may be sanitized to remove sensitive and/or confidential information by focusing on document structure or terms that are general for such a document type without including particular information (e.g., party names, particular wage amount, etc.). Terms may be provided a definition by the user(s), which may facilitate recognition of similar or synonymous terms during a review to be tagged. The system may also parse an uploaded document and recommend that such similar or synonymous terms be tagged upon the recognition or tagging of a particular term.

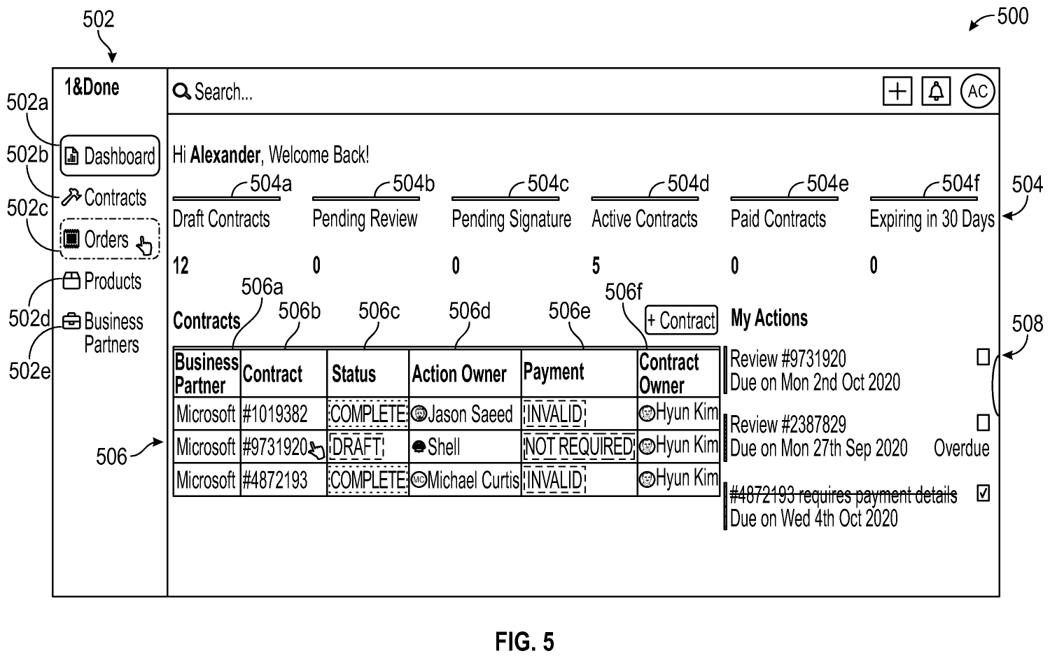

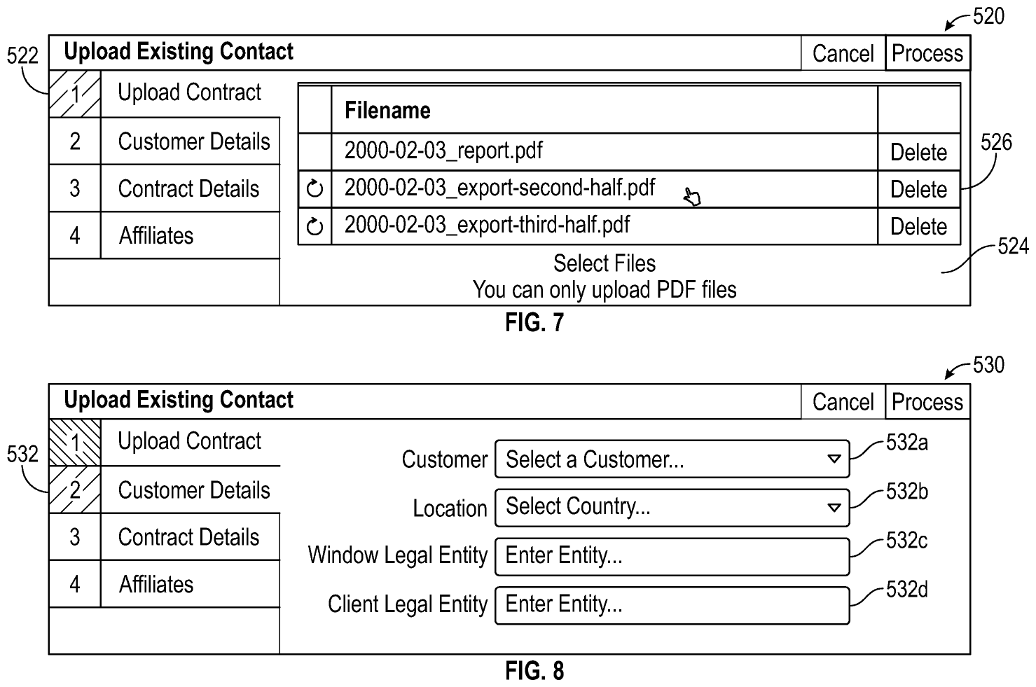

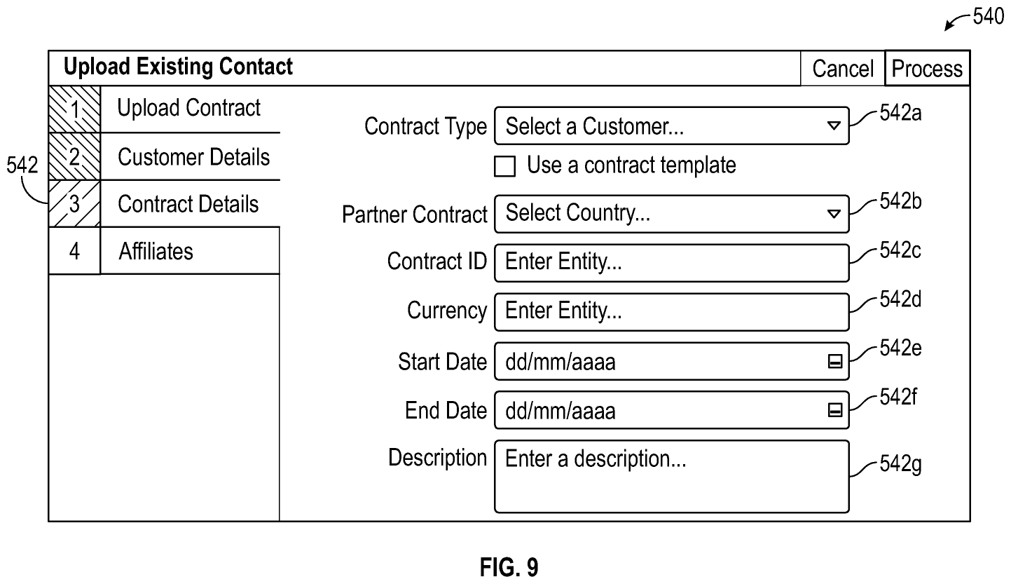

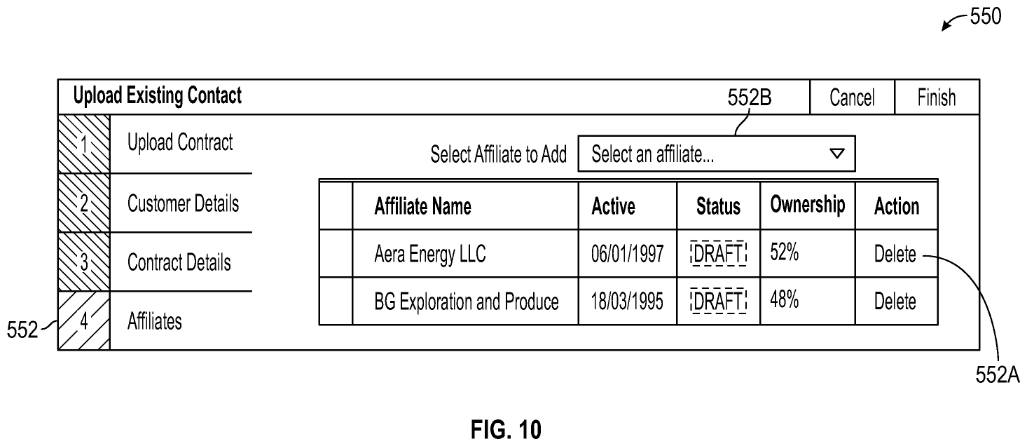

A document wizard 218 may facilitate compliance with document reviewers to ensure that certain items are tagged or reviewed within the document. In addition, the platform 200 may highlight areas within an uploaded document that the system determines have a likelihood (e.g., percentage match) with items identified as corresponding to areas to be tagged within a document. The platform 200 may additionally or alternatively provide a checklist for a reviewer such that during review of the document terms or sections within a document are highlighted and/or tagged as corresponding with the items provided within the checklist. A frontend 220, which is a software program or a program providing a user interface may provide an interface for users (e.g., clients) to upload documents or generate documents and to tag those documents. The frontend 220 may provide a document tagging wizard 222. Various user interfaces 500, 510, 520, 530, 540, 550, 560, and 580 for uploading documents, viewing, and managing activities and information related to documents are also discussed with respect to FIGS. 5-12.

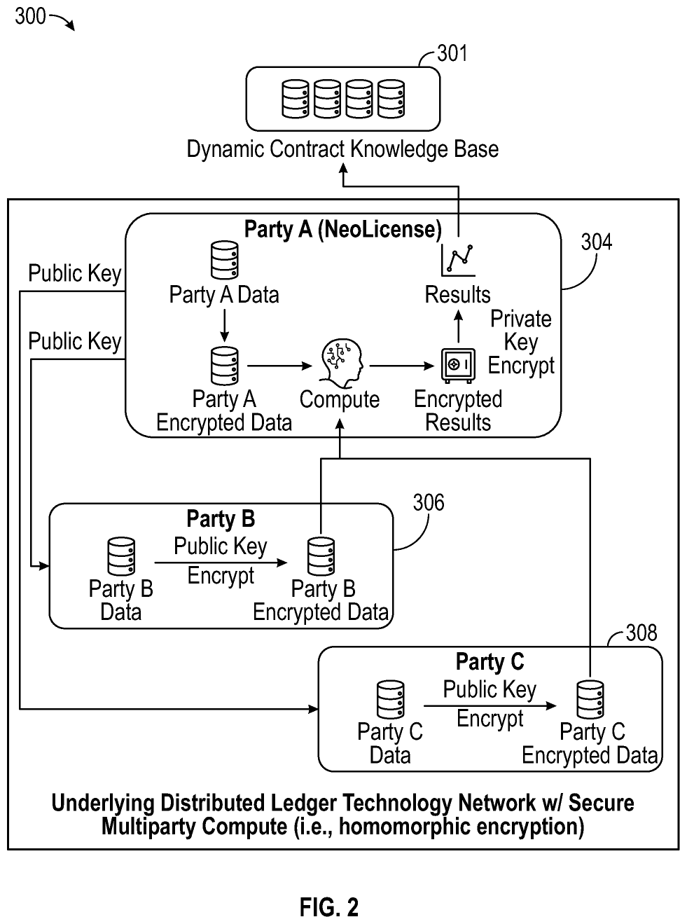

The DTP 200 may include an online frontend or user interface where a client can upload a document to facilitate review and/or tagging of the uploaded document with a document tagging wizard (DTW) 222. As shown in FIG. 2, a schematic diagram illustrates how systems according to embodiments of the present disclosure can share, analyze, and act on sensitive, proprietary, and confidential data across a collection of multiple vendors, publishers, and business partners. For example, the system 300 may include a dynamic contract knowledge base 301, which may dynamically update information stored in the database and algorithms for identifying commonalities amongst documents and for providing analytics. The systems may communicate amongst a plurality of parties, including a first party 304, a second party 306, and/or a third party 308. Parties 306 and 308 may each utilize the client device 100 described above, for uploading documents and inputting data. The communications amongst the party may protect proprietary information while still collecting information for processing and analysis. For example, there may be an underlying homomorphic encryption that allows multi-party secure computations across the distributed network. In a scenario, Party A may utilize its knowledge base 301 to process, compute, and analyze proprietary data from Party B and Party C. Party A may utilize its processing and computing algorithm. Advantageously, homomorphic encryption may be utilized such that the Parties A-C may work together to process their respective data without sharing access to the data or the details of the algorithm amongst the parties. As referred to herein, the knowledge base 301 may refer to components of the DTP 200, which may include the document database 208, the document tagging rules 212, the customized tagging rules 214, and/or the analytics platform data 216. Accordingly, the knowledge base 301 evolves and learns as more documents are uploaded and tagged as the document database 208 receives additional documents and the document tagging rules 212 and/or the customized tagging rules 214 are updated.

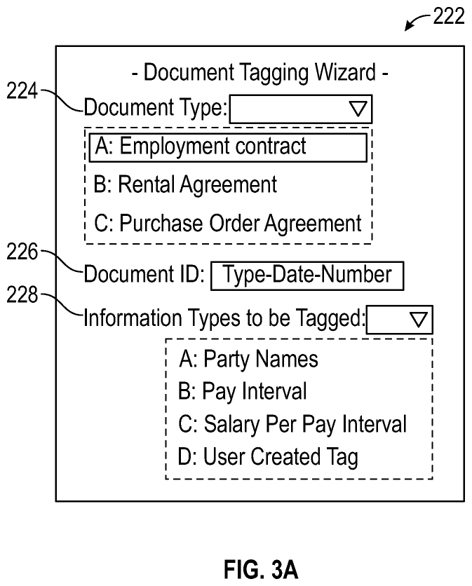

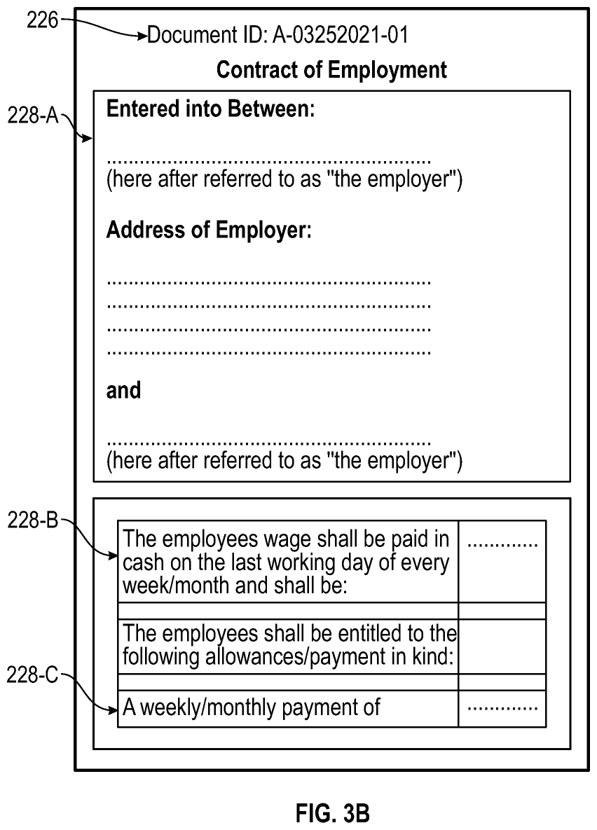

Referring to FIG. 3A, the document tagging wizard 222 may include a guided or structured document review. For example, a client who has uploaded a document may manually enter information as requested by the DTW 222. The DTW may initially scrape the document and narrow the choices provided by the DTW. For example, based on identified structure and/or key terms, the DTW may determine that a document type is one of (A) employment contract; (B) rental agreement; (C) purchase order agreement. This may be based on a percentage match with other such documents that are stored in the document database 208. The percentage match may be matching key terms, including identical matching and/or synonym word usage, and/or similarity in document structure.

The document type 224 may be provided in the form of a drop-down menu providing a list of different document types that the client selects. The document ID 226 may be automatically generated and/or entered by the client. The document ID may be provided in the form of TYPE (e.g., an employment contract may be grouped as type “A”, and rental agreements may be grouped as type “B”, etc.), date (MM-DD-YYYY) and number (sequentially provided based on the number of such type of documents that are reviewed on that date). The DTW 222 may provide a checklist of information types that are to be tagged within the uploaded document. The DTW 222 facilitates a forced compliance to ensure all information for a particular document type is tagged. In the event such information is missing, however, the client may indicate that such information is missing, which is also useful in the review of a document. Alternatively, the client may override the DTW 222 and customized the information that is to be tagged in the document. For example, where an employment contract “A” has been identified as the document type in item 224 of the DTW 222, the information types to be tagged 228 may include: party names, pay interval, salary per interval, and/or user created tag(s).

An example of a guided document review as provided by the DTW 222 is shown in FIG. 3B. For example, an employment contract may be uploaded in the DTP 200. As the term “employment” appears in the document, the document may be automatically detected as being a type “A” and the date of the upload, e.g., Mar. 25, 2021 may be identified as 03252021, and since this is the first of that document on that date, the number “01” may be assigned such that the document ID 226 may be provided as A-03252021-01”. The DTP 200 may have identified the document as an employment contract as it may have identified the term “employment” and related terms such as “wage” appearing within the document such that a matching percentage or correlation score may have been ascertained such that a threshold likelihood percentage was determined to automatically make the determination or to suggest to the client/user that the document is an employment contract and/or other document type possibilities (e.g., rental agreement or purchase order agreement) which may be possible document type based on those or other terms within the document or the way that the document has been structured. Once the document has been identified as a particular type, terms and/or sections within the document 228-A, 228-B, 228-C may be identified by the DTP 200 and/or for the client/user to identify. For example, section 228-A may be highlighted by the client/user and tagged as being related to the “party names,” section 228-B may be tagged as being related to the “wage”, and section 228-C may be tagged as being related to the “pay interval.” The user/client may further tag and highlight sections within the document that should be tagged and/or highlighted. The data (e.g., wage) of the highlighted or tagged information may be separately saved as the wage within the system for the corresponding document ID 226.

Based on what the user/client has tagged and/or highlighted for a document for a particular type, a self-learning function for the DTP 200 may include querying future clients/users to highlight/tag such information when future uploaded documents of the same type are uploaded into the DTP 200. This may be referred to herein as a dynamic contract knowledge (DCK) base that may grow and be scaled for speed and efficiency. As more documents are reviewed by the system, the ability to identify and suggest a guided document review increases exponentially. AI crated tagging facilitates highly accurate and fast tagging processes that is more accurate, faster, and efficient than traditional self-guided manual tagging processes. Advantageously, AI created tagging such as that described herein enforces data and quality tagging that is established and only possible by the dynamic contract knowledge base 301. For example, the system provides scalability and learning from all documents that are reviewed regardless of the experience of the particular user/client in reviewing a particular document type.

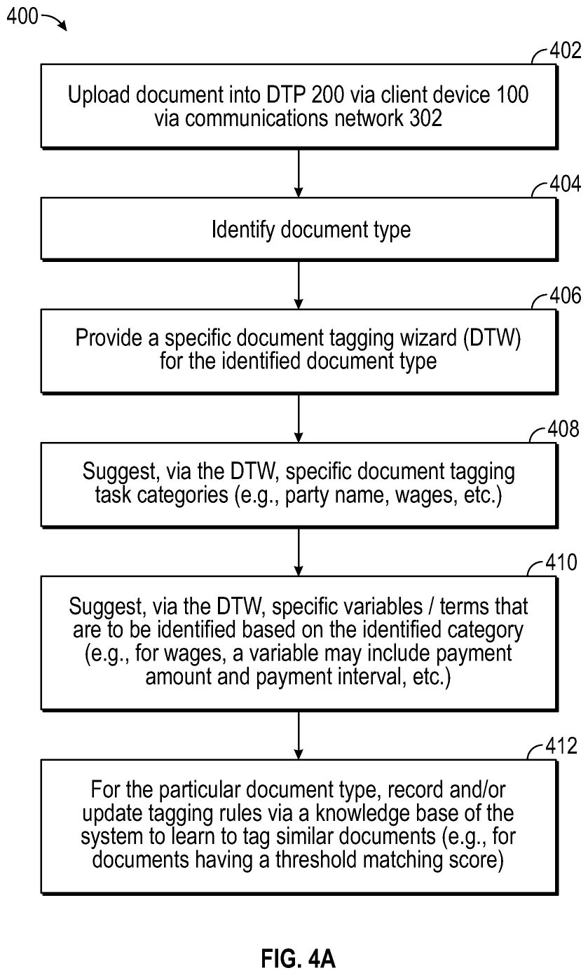

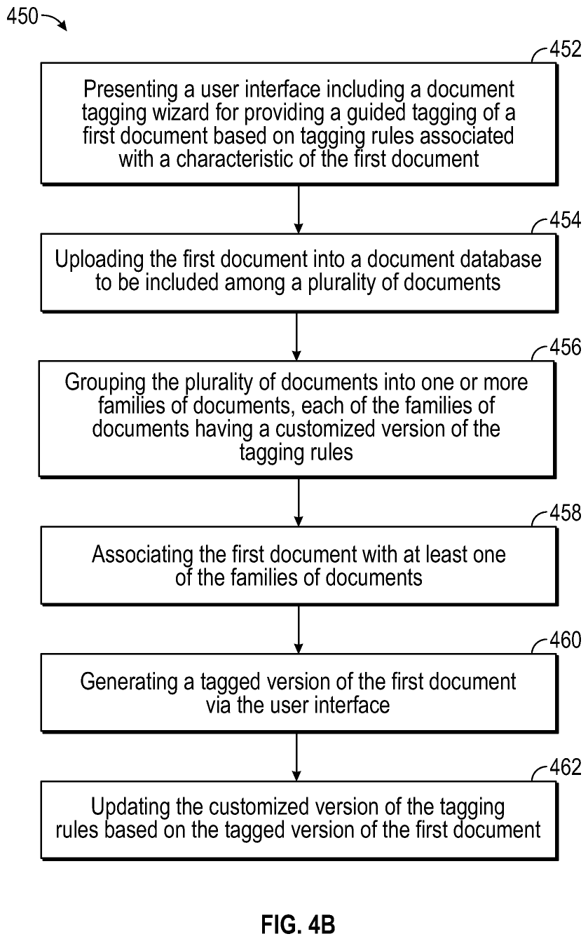

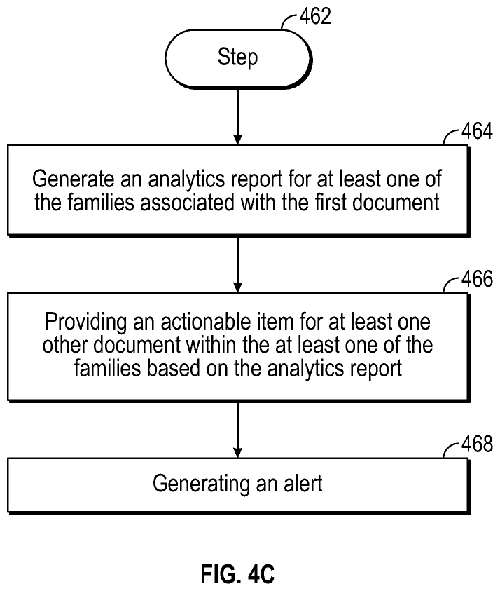

A method 400 of dynamic tagging is described with respect to FIG. 4A. The method may include, step 402 may include uploading a document into the DTP 200 via the client device 100 via the communications network 302. A further step 404 may include identifying the document type. Step 406 may include providing a document tagging wizard DTW 222 which may be dynamically particularized for the identified document type. For example, the queries and steps provide by the DTW 222 are dependent upon the identified document type. At step 408, the DTW suggests particularized and specific document tagging categories. For example, particular contracts would include often include specific and related terms. If such terms are absent, a warning may be presented to the client/user to flag the document for further review and/or suggest that the document may require modifications. Step 410 may include suggesting specific variables or terms to be identified based on the category. In other words, after a document type has been identified (e.g., employment contract), categories (e.g., wage) may be identified, within the identified categories, variables (e.g., payment interval, legal jurisdiction, etc.) may then be identified. The system may suggest such types, categories, and variables, and the client/user may then highlight and/or tag, via the system, corresponding sections of the uploaded document. At step 412, the system may learn and adapt for future uploaded documents. For example, for the particular document type, tagging rules may be recorded and/or updated in a knowledge base 301 of the system such that the system learns to analyze similar documents when they are updated. Step 412 may include updating the algorithms for grouping documents into documents and also for the tagging rules in response to the uploading of new documents. Thus, the system perpetually improves. When the system receives an uploaded document, the identification of document types, categories within the document, and variables within the categories that are to be tagged may be based on a matching score with documents that are stored in the document database and upon the tagging rules/algorithm that is already stored and which may also be updated.

A method 450 in accordance is described with respect to FIG. 4B, which may be implemented by the systems (e.g., DTP 200) described herein. At step 452, a user interface may be presented, for example, to be displayed on the client device 200. The user interface may include a document tagging wizard for providing a guided tagging of a first document based on tagging rules. The tagging rules that are utilized may be customized for the particular characteristic(s) (e.g., document type (e.g., contract) and family (e.g., client name) of the uploaded first document. At step 454, the first document may be uploaded into a document database (e.g., document database 208). At step 456, the plurality of documents that are now contained in the document database, which now includes the uploaded first document, may be grouped into one or more families of documents, which may be based on relationships, such as same client, subsidiary of client, and/or partner of client) and may also provide a hierarchical grouping (e.g., parent document and child document (e.g., an appendix)). At step 458, the first document may be associated with at least one of the families of documents. The groupings and/or associations of documents may be based upon any desired or meaningful way of grouping and classifying documents by their shared characteristics, which may include ownership and/or type of document. Separate documents may include information that is pertinent to other documents in the database and as such tagging of information of one document may have an affect on other documents contained in the database. At step 460, a tagged version of the first document may be generated via the user interface as described, for example, hereinbelow with reference to FIGS. 5-12.

As shown in FIG. 4C, at step 464, an analytics report for at least one of the families associated with the first document may be generated in response to the tagging of the uploaded, first document. At step 466, an actionable item for at least one other document within the at least one of the families may be provided and the actionable item may be based on the analytics report. At step 468, an alert may be generated so that actionable steps may be taken based on the analytics by alerting those people and parties associated with particular documents. For example, in response to generating a tagged version of an uploaded document, the analytics may determine that a tagged term (e.g., a change in rate or delivery date, etc.) is material to other related documents and that certain actions may be necessary.

FIGS. 5-12 illustrate various embodiments of user interfaces of the DTP 200 of the system 300 and that may be accessed by various client devices 100.

As shown in FIG. 5, a user interface 500 may include a plurality of interface elements for viewing and entering data into the DTP 200. The user interface 500 may include a menu 502 that includes a dashboard tab 502a, a contracts tab 502b, an orders tab 502c, a products tab 502d, and/or a business partners tab 502e. In FIG. 5, the dashboard tab 502c and a display information 504 may include a plurality of elements 504a-f including displaying information pertaining to particular documents, for example, an indication as to the number of the following: draft contracts 504a, contracts pending review 504b, contracts pending signature 504c, contracts active contracts 504d, paid contracts 504e, and expiring contracts 504f in a predetermined amount of time (e.g., 30 days) such that the display information 504 alerts users at a glance as to actionable activities that should be taken for particular documents (e.g., contracts). A listing of contracts may include providing relevant information for the contracts such as a business partner 506a, a contract 506b, a status 506 (e.g., draft, pending, and/or complete), an action owner 506d, a payment 506e (e.g., invalid, valid, required, and/or not required), and/or a contract owner 506f. An action list 508 may provide a listing of recent actions taken for particular documents (e.g., contracts).

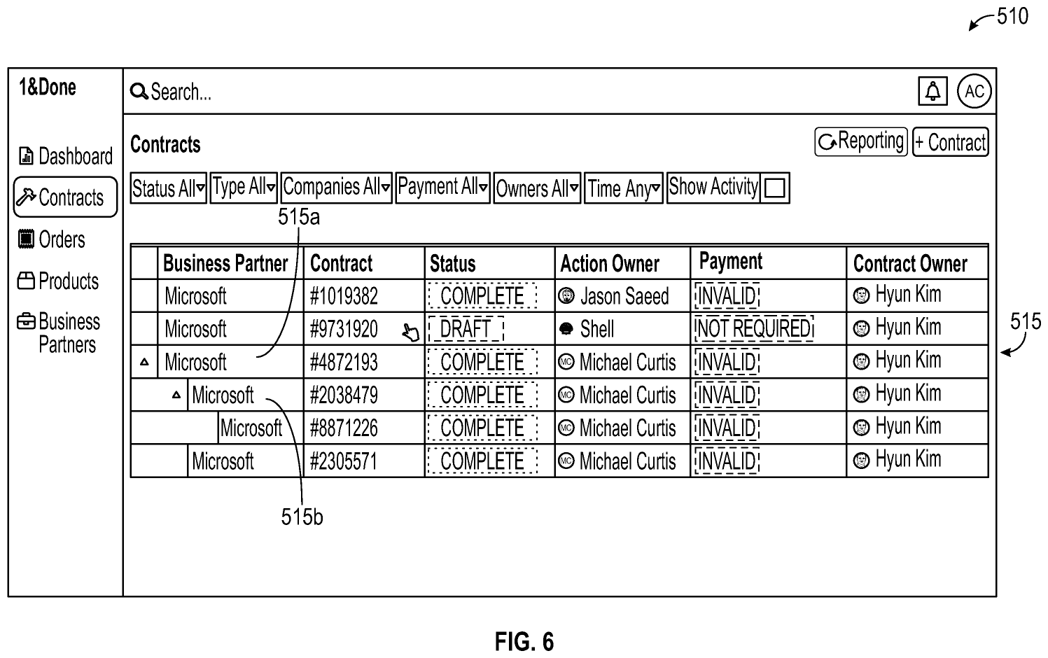

As shown in FIG. 6, an interface 510 for creating a document (e.g., a contract) is shown. The interface 510 may provide a visual indication 515 of the relationship between a created document and other documents. For example, the visual indication 515 may be a hierarchical representation (e.g., family tree or indentations) that provide an indication of the relationship amongst documents. That is, the DTP 200 may group the documents contained in the document database 208 into families or groups and the specific groupings of the document (e.g., parent-child relationship) may be visually represented via the interface 510. Upon indication that a change has occurred in one document within a family of documents, an alert and/or modification may occur for all members within the family of documents. In addition, a change may result in a modification in the knowledge base 301 such that as new documents are created and/or uploaded, during a tagging process, a user may be directed to tag (e.g., identify) particular terms or sections within the document.

Documents may be generated natively through the system 300 and/or may be uploaded, whereupon the contents of the document may be parsed through, for example, an optical character recognition (OCR) software in which a PDF document may be converted to a text document. A user interface 520 may be presented by selecting an upload contract tab 522 and may include a space 524 in which a document may be uploaded (e.g., dragged and dropped) and a listing 526 of documents may be presented that provides a listing of documents which may be selecting for review. The uploaded document may be natively created within the system 300 and such creation may be guided according to predetermined rules and/or templates. Alternatively, the uploaded document may be provided by an external source.

The system 300 may automatically identify categories and/or variables (e.g., terms) within the document and present such identified categories and/or variables to the user for review. The user may tag additional and/or different categories and/or variables within the document. Preferably, based on predetermined rules for tagging, the system 300 ensures compliance and consistency amongst different reviewers regardless of their particular subject matter expertise or experience, thereby ensuring a more complete and accurate document review.

An interface 530 for editing and/or selecting document attributes, which may include customer details for a customer associated with the document is illustrated in FIG. 8. For example, an entry window 532a may provide a dropdown menu to select amongst customers. Each customer listed may have a predetermined set of rules for reviewing and/or analyzes uploaded or generated documents. For example, upon selection of the customer, particularly associated document tagging rules 212, and/or customized tagging rules 214 may be applied and such that a customized DTP 222 may be generated for documents associated with particular document attributes (e.g., associated customer for a document). An entry window 532b (e.g., a dropdown window) may provide a dropdown menu or input for the user to provide a location for the document (e.g., for US or EU, etc.) as different locations may be in different legal jurisdictions and would therefore be a factor to consider when applying the customized DTP. Other input windows may include, for example, a vendor legal entity 523c and/or a client legal entity, and/or may be user defined.

A user interface 540 may provide an interface for a user to enter other attributes. For example, by selecting a contract details tab 542, a user may be guided to input additional contract details that are associated with the document that is being generated and/or uploaded. For example, contract detail attribute input windows may include: contract type 542a, parent contract 542b, contract ID 542c, currency 542d, start date 542e, end date 542f, and/or description 542g.

A user interface 550 may provide an interface for a user to associate the uploaded or generated document with one or more affiliates. By selecting an affiliates tab 552, affiliate's 552A that are associated with a particular document may be listed. An input window 552B for selecting or adding an affiliate to be associated with the uploaded or generated document.

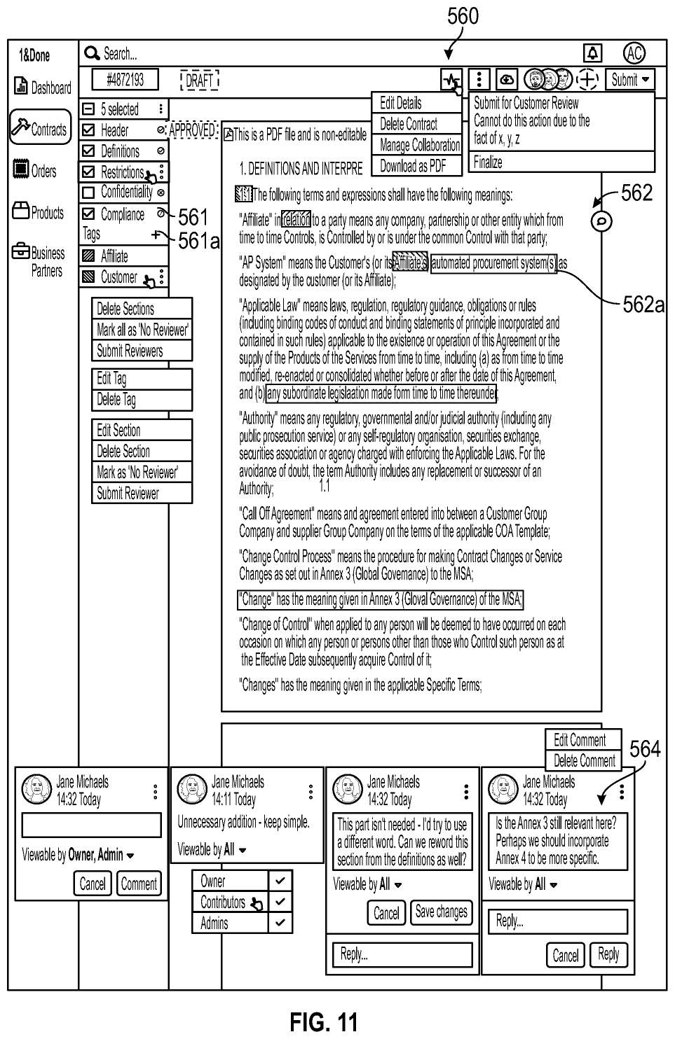

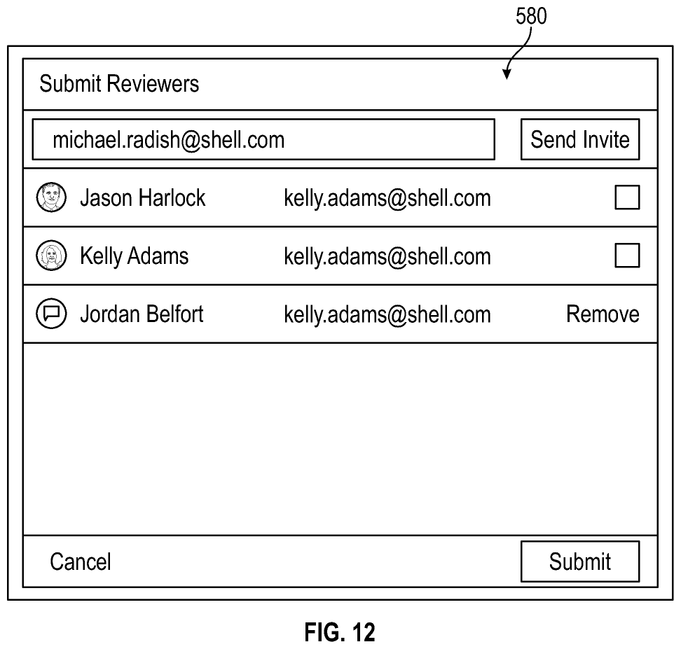

A front end for the DTP 200 may include the user interface 560, which is shown in FIG. 11. The user interface 560 may include a compliance tab 561 and one or more tagging tabs 561a for particular items that are to be tagged for particular categories. A window 562 in which a copy of the document is viewable and taggable by identifying or highlighting portion(s) 562a of the document with a particular tag, which may be color coded pertaining to a particular document detail (e.g., contractual term). Tags 564 associated with one or more reviewers may be viewed in the user interface 560 so that comments on the tagged items may be left for further review and/or collaboration amongst reviewers. As shown in FIG. 12, the created, uploaded, and/or tagged document may be sent to different reviewers via a communication window 560.

While the present disclosure may have been shown and described with reference to various embodiments thereof, it will be understood by those skilled in the art that various changes in form and details may be made therein without departing from the spirit and scope of the present disclosure as defined by the appended claims and their equivalents. In other words, the various exemplary embodiments disclosed in the present specification and drawings are merely specific embodiments to facilitate an understanding of the various aspects of the present disclosure and are not intended to limit the scope of the present disclosure. For example, the particular ordering of steps may be modified or changed without departing from the scope and spirit of the present disclosure. Therefore, the scope of the present disclosure is defined not by the detailed description of the disclosure but by the appended claims, and all differences within the scope should be construed as being included in the present disclosure.

What is claimed is:

1. A system comprising a memory and at least one processor operatively coupled to the memory, the processor being configured to:
present a user interface including a document tagging wizard for providing a guided tagging of a first document based on tagging rules associated with a characteristic of the first document;
upload the first document into a document database to be included among a plurality of documents;
group the plurality of documents into one or more families of documents, each of the families of documents having a customized version of the tagging rules;
associate the first document with at least one of the families of documents;
generate a tagged version of the first document via the user interface; and
update the customized version of the tagging rules based on the tagged version of the first document.

2. The system of claim 1, wherein the processor is further configured to:
generate an analytics report for the at least one of the families of documents associated with the first document.

3. The system of claim 2, wherein:
the analytics report provides an actionable item for at least one other document within the at least one of the families of documents associated with the first document.

4. The system of claim 3, further comprising:
generating an alert based on the actionable item.

5. The system of claim 1, wherein:
the user interface includes a first input component for identifying a portion of the first document.

6. The system of claim 5, wherein:
the user interface includes a second input component for identifying a variable of the first document.

7. The system of claim 6, wherein:
the variable is the characteristic of the first document associated with the tagging rules.

8. The system of claim 7, wherein the processor is further configured to:
associate the identified portion of the first document with the variable of the first document.

9. The system of claim 7, wherein the variable includes a customized list of variables based on the customized version of the tagging rules.

10. The system of claim 7, wherein:
the variable includes a contractual term.

11. The system of claim 7, wherein:
the variable includes a legal jurisdiction.

12. A method comprising:
presenting a user interface including a document tagging wizard for providing a guided tagging of a first document based on tagging rules associated with a characteristic of the first document;
uploading the first document into a document database to be included among a plurality of documents;
grouping the plurality of documents into one or more families of documents, each of the families of documents having a customized version of the tagging rules;
associating the first document with at least one of the families of documents;
generating a tagged version of the first document via the user interface; and
updating the customized version of the tagging rules based on the tagged version of the first document.

13. The method of claim 12, wherein the processor is further configured to:
generating an analytics report for the at least one of the families of documents associated with the first document.

14. The method of claim 13, wherein:
the analytics report provides an actionable item for at least one other document within the at least one of the families of documents associated with the first document.

15. The method of claim 14, further comprising:
generating an alert based on the actionable item.

16. The method of claim 12, wherein:
the user interface includes a first input component for identifying a portion of the first document.

17. The method of claim 16, wherein:
the user interface includes a second input component for identifying a variable of the first document.

18. The method of claim 17, wherein:
the variable is the characteristic of the first document associated with the tagging rules.

19. The method of claim 18, further comprising:
associating the identified portion of the first document with the variable of the first document.

20. The method of claim 18, wherein:
the variable includes a customized list of variables based on the customized version of the tagging rules.
